(19) United States
(12) Patent Application Publication
(10) Pub. No.: US 2011/0061041 A1
(43) Pub. Date: Mar. 10, 2011

(54) RELIABILITY AND AVAILABILITY MODELING OF A SOFTWARE APPLICATION

(75) Inventors: Holger Hellebro, Upplands Vasby (SE); Mohammad A. Sanamrad, Lidingo (SE)

(73) Assignee: International Business Machines Corporation, Armonk, NY (US)

(21) Appl. No.: 12/849,107

(22) Filed: Aug. 3, 2010

(30) Foreign Application Priority Data
Sep. 4, 2009 (EP) 09169516.3

(51) Int. Cl. G06F 9/44

(52) U.S. Cl. 717/120

(57) ABSTRACT

Reliability and availability modeling of a software application is provided. A reliability and availability model is generated in the form of a white-box model of a software application. An existing model of the software application's structure and behaviour is inspected and/or the software application is inspected. The accuracy of the reliability and availability model is determined and reliability and availability metrics for the software application are calculated. Additional input parameters relating to the software application's performance may be determined and the additional input parameters may be added to the reliability and availability model.

### BACKGROUND

Exemplary embodiments relate to the field of modeling of software applications. In particular, the exemplary embodiments relate to reliability and availability modeling of a software application.

While software applications are a key element in many offerings and directly contribute to the end-to-end availability of the Information Technology (IT) system, much of the high availability design effort has been focused on hardware and system software such as operating systems and middleware.

In designing software applications for high availability and considering their impact on the availability of the end-to-end solution, models can be created. In principle, there are two types of reliability models for modelling software applications, black-box reliability models and white-box reliability models.

Black-box reliability models, where the software application is treated as a whole, can provide reliability estimations using a probabilistic model for when failures occur based on the estimated number of remaining defects in the software and an estimated failure rate for when the defects result in failures. As these models do not consider the internals of the software application, they cannot make any a priori judgement of reliability, or compare the result of different internal design choices. Nor can they model the effects of different reliabilities of the components of the application, something that is becoming increasingly common as applications are developed in a heterogeneous environment and some components are reused and even acquired.

White-box reliability models explicitly consider the static and dynamic structure of the software application in order to determine the reliability. They can also indicate components that are sensitive from a reliability perspective and can consider the effects of failures in internal interfaces. While white-box models have the expressiveness required to model many desired aspects, e.g. the effects of different designs, dependencies between components, and the impact of design complexity, they are quite theoretical and difficult to apply to a real-life software system.

Some graphical tools are available for visualizing and modelling reliability for various hardware and physical systems; however, they cannot readily be applied to software applications. This is because the software architecture is not considered, which means that the software must either be modelled as a black box (with limitations as above), or modelled as a number of independent components. In the latter case, the reliability estimate will not be accurate since dependencies and interactions between the components are not modelled.

### BRIEF SUMMARY

Known tools that specifically describe ways of determining software reliability and availability primarily use black-box modelling techniques.

As a result, none of the tools and systems described in the prior art can provide an effective environment in which to assess a software system's reliability, e.g. by determining the individual components' reliability and their impact on the end-to-end availability. This is especially important in a service oriented architecture (SOA) context where a large number of components implemented using a variety of technologies are integrated into business processes, sometimes in unforeseen ways. Determining the reliability and end-to-end availability of such business processes is key to ensuring conformance to the non-functional requirements and without having a tool that automates part of this work, there is a high risk that the analysis is never done or is done by ad hoc methods resulting in an unreliable estimate.

According to a first exemplary embodiment, there is provided a method of reliability and availability modeling of a software application which includes generating a reliability and availability model in the form of a white-box model of a software application. This includes inspecting at least one of an existing model of the software application's structure and behaviour and the software application, determining the accuracy of the reliability and availability model, and calculating reliability and availability metrics for the software application.

According to another exemplary embodiment, there is provided a system of reliability and availability modeling of a software application. The system includes a generating component to generate a reliability and availability model in the form of a white-box model of a software application. The generating component includes obtaining information from a model interface to inspect an existing model of the software application's structure and behaviour and/or an application interface to inspect the software application. The generating component further includes obtaining information from an accuracy determining component to determine the accuracy of the reliability and availability model, and a calculating component to calculate reliability and availability metrics for the software application.

Other exemplary embodiments include a computer program product for reliability and availability modeling of a software application and a reliability and availability modelling system may be provided as a service to a customer over a network.

### BRIEF DESCRIPTION OF THE SEVERAL VIEWS OF THE DRAWINGS

The subject matter regarded as the exemplary embodiments is particularly pointed out and distinctly claimed in the concluding portion of the specification. The exemplary embodiments, both as to organization and method of operation, together with objects, features, and advantages thereof, may best be understood by reference to the following detailed description when read with the accompanying drawings in which:

FIG. 1 is a block diagram of a system of reliability and availability modeling including a modeling system in accordance with the exemplary embodiments;

FIG. 2 is a block diagram of a modeling system in accordance with the exemplary embodiments;

FIG. 3 is a block diagram of a computer system in which the exemplary embodiments may be implemented; and

FIG. 4 is a flow diagram of a method in accordance with the exemplary embodiments.

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numbers may be repeated among the Figures to indicate corresponding or analogous features.

### DETAILED DESCRIPTION

In the following detailed description, numerous specific details are set forth in order to provide a thorough understanding of the exemplary embodiments. However, it will be understood by those skilled in the art that the exemplary embodiments may be practiced without these specific details. In other instances, well-known methods, procedures, and components have not been described in detail so as not to obscure the exemplary embodiments.

The described method and system provide a tool for determining and predicting reliability and availability characteristics of a software application by using a white-box reliability model which considers the static and dynamic structure of the software application. The method describes how the design of the software application is translated into the model, and the tool can be used to specify design alternatives and provide suggestion for unknown parameters.

Outputs from the tool are the predicted reliability and availability characteristics of the software application in absolute terms or relative to some agreed measurement (for example, the relative availability of two different designs). This information will allow an IT architect to estimate an application's reliability and availability accurately, thereby reducing the risk of over-engineering the solution or falling short of meeting the availability goals. In addition, by identifying sensitive components (“reliability hotspots”), the quality engineering effort (for example, code reviews and testing) can be distributed efficiently by focusing on the most sensitive components.

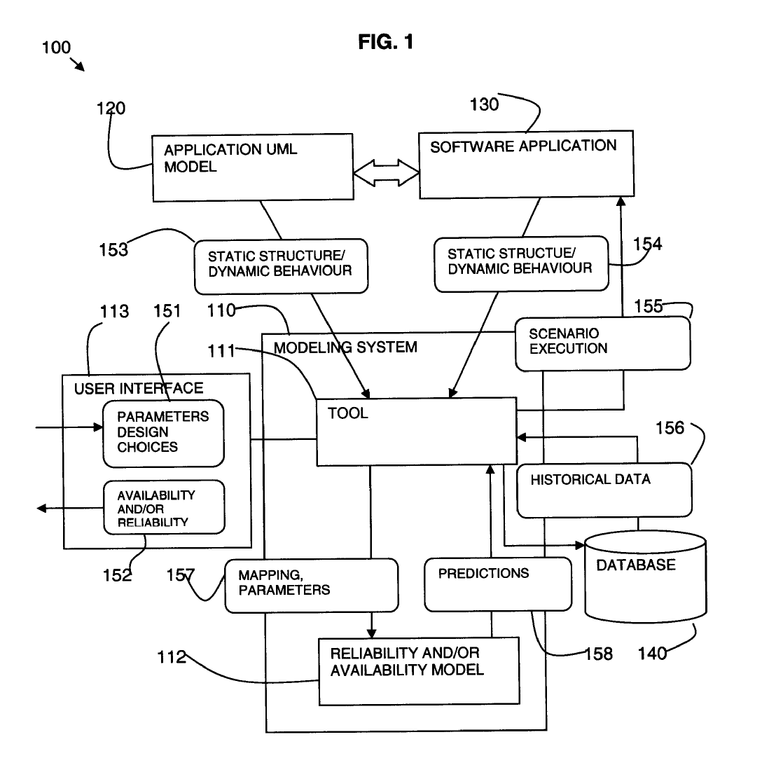

Referring to FIG. 1, a block diagram shows a system 100 of reliability and availability modelling including a modelling system 110. The modeling system 110 is provided including a tool 111 for creating a reliability and availability model 112 for assessing and estimating the reliability and availability characteristics of computer software applications.

The tool 111 is used to model planned or existing software applications which may be formed of one or more components. While the tool is described as being aimed at modelling software applications, it can be applied to other systems, for example, where some components are hardware components and/or contain software in the form of firmware or micro code embedded in hardware components.

The tool 111 has a user interface 113 for input of parameters or design choices 151 by a user and for output of the predicted reliability and availability characteristics 152 as absolute or relative values.

The modeling system 110 integrates with an application model 120, for example, a UML (unified modeling language) model. The modeling system 110 alternatively or additionally integrates with the software application 130 itself or a prototype of the software application. The modeling system 110 may also access a database 140 of historical data.

The tool 111 inspects the application model 120 and obtains static structure and dynamic behaviour information 153. The tool 111 also or alternatively inspects the software application 130 and obtains static structure and dynamic behaviour information 154. Either of these information sources or a combination of them is used to build a reliability and availability model as a white-box model. Details of a software application architecture may also be entered manually.

The tool 111 can generate scenarios or tests 155 for input into a running instance of the software application 130 to obtain performance parameters. Historical data 156 can be obtained from the database 140.

The tool 111 inputs mappings, parameters (specified or measured) 157 into the reliability and availability model 112 and obtains predictions or goodness-of-fit information 158 or uncertainty quantification information such as confidence intervals. From a reliability model, an availability model can be obtained by supplying additional parameters, primarily regarding repair and recovery of failed components.

The described tool and method provide a structured and efficient manner of creating a white-box model of a planned or existing software application. Then the tool uses the model to determine (by calculation and/or simulation as appropriate) various reliability and availability characteristics of the software application.

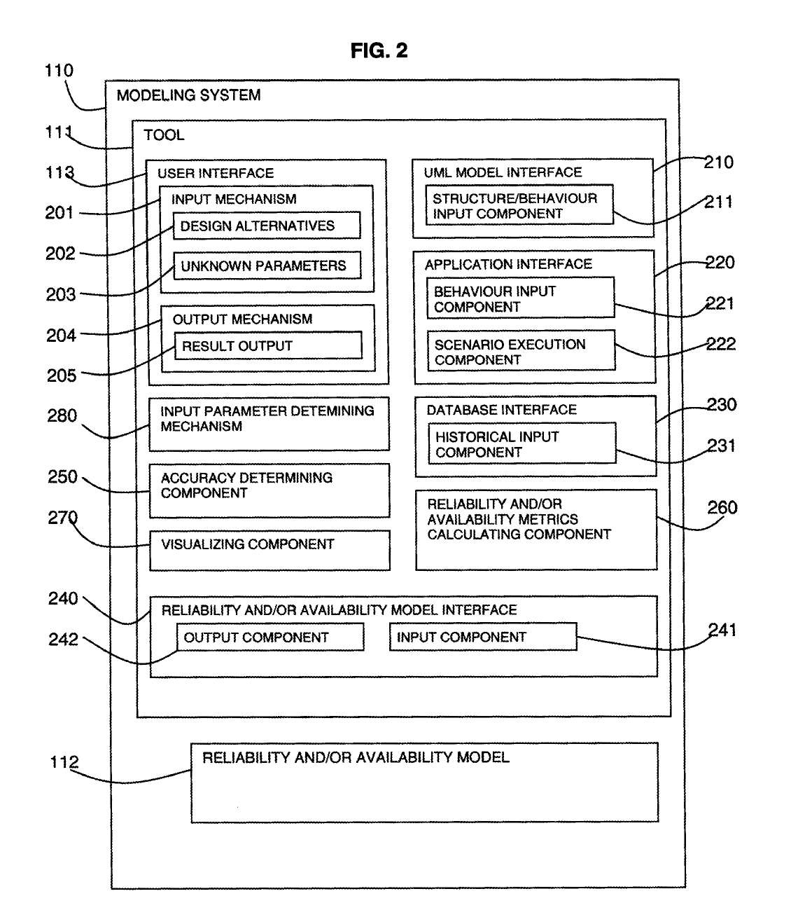

Referring to FIG. 2, details of the components of the modeling system 110 of FIG. 1 including the tool 111 are shown. The tool 111 includes a user interface 113 including an input mechanism 201 for inputting design alternatives 202 and unknown parameters 203. An output mechanism 204 of the user interface 113 includes the reliability and availability result output 205.

The tool 111 includes a model interface 210 for interacting with an existing model such as a UML model. The model interface 210 includes a structure/behaviour input component 211. The tool 111 also includes an application interface 220 for interacting with the software application to be modeled or a prototype of it. The application interface 220 includes a structure/behaviour input component 221 and a scenario execution component 222 for testing a running instance of the software application with scenarios. The tool 111 also includes a database interface 230 including an input component 231 for historical data.

The tool 111 includes a reliability and availability model interface 240 for interfacing with the reliability and availability model 112 as generated from the obtained software application information from the existing model and/or the software application itself or a prototype of it. The reliability and availability model interface 240 includes an input component 241 to the reliability and availability model 112 of mappings, parameters (specified or measured) for building and changing the reliability and availability model 112 and an output component 242 from the reliability and availability model 112 for returning predictions of behaviour and goodness-of-fit information. The tool 111 includes a parameter determining mechanism 280 for input of parameters.

The tool 111 also includes an accuracy determining component 250 for determining the accuracy of the reliability and availability model 112 and a calculating component 260 for calculating reliability and availability metrics for the software application and, optionally, a visualizing component 270 for display of the reliability and availability metrics.

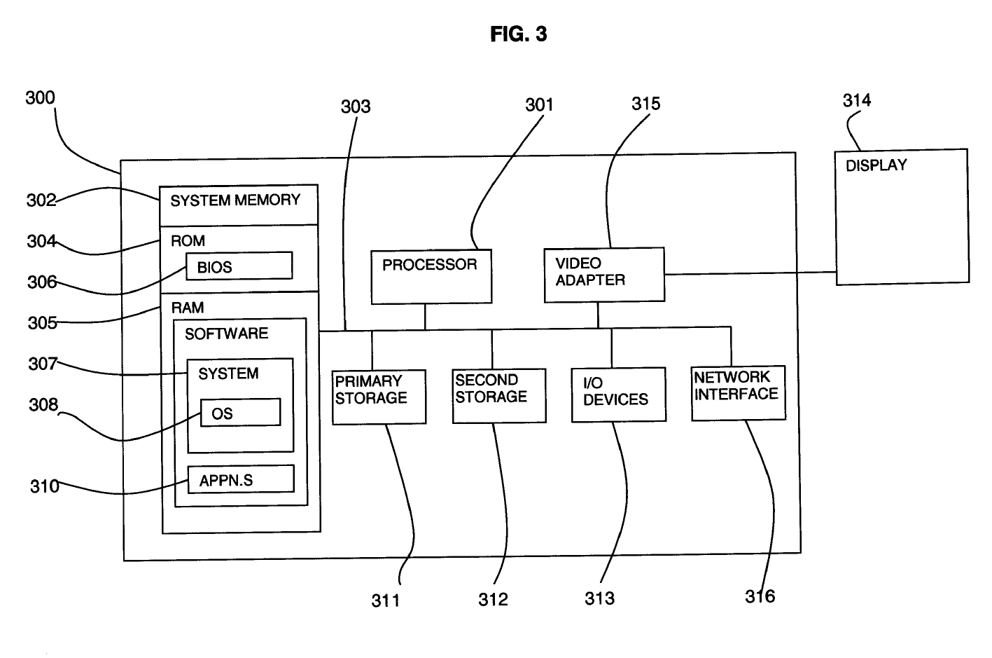

Referring to FIG. 3, an exemplary system for implementing aspects of the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

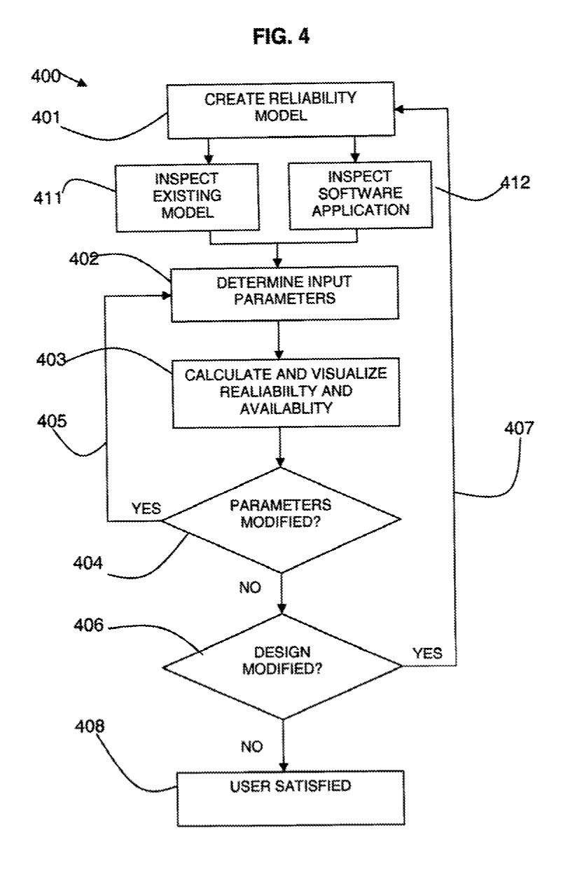

Referring to FIG. 4, a flow diagram shows a high-level method of the described reliability and availability modelling. The flow diagram illustrates a method working with the described tool 111 as shown in FIG. 2.

At a first step, a reliability and availability model 112 is created 401 based by a) having the tool 111 inspect 411 an existing UML model using the UML model interface 210, b) having the tool 111 inspect 412 an existing application using the application interface 220, or c) by a combination of a) and b). The results of the automatic generation of the reliability and availability model 112 can be complemented by manually entering details of the application architecture via the input mechanism 201 of the user interface 113.

At a next step, additional input parameters (for example, component reliabilities, failure rates, execution times) are determined 402 using the input parameter determining mechanism 280 which are specified, estimated, or drawn from historical data via a database interface 230.

At a further step, the reliability and availability model 112 is solved 403 to determine the accuracy of the model by the accuracy determining component 250 and reliability and availability metrics are calculated by a calculating component 260 and visualised by a visualizing component 270 of the tool 111.

At a following step, it is determined if the user of the tool 111 selects to modify 404 parameters 203 of the application using the input mechanism 201 of the user interface 113 to assess the impact on the reliability and availability. If so, the flow loops 405 to determining input parameters 402 and the method continues.

At a following step, it is determined 406 if the user of the tool selects to modify 404 the design 202 of the application using the input mechanism 201 of the user interface 113 to assess the impact on the reliability and availability. If so, the flow loops 407 to creating 401 the reliability model which is correspondingly modified and the method continues.

If neither the parameters nor design are modified, the user is satisfied with the results and ends 408 the session.

The tool accepts as input a plurality of characteristics of the application at hand and its behaviour. For example:

Static structure of the software application, entered or derived from a UML static model of the application.

Static properties of individual components, specified directly or retrieved from metrics or reports. E.g. complexity of code, and adherence to coding best practices and conventions.

Dynamic behaviour of the application, potentially represented as a call graph for a given scenario. This information could be retrieved from a UML dynamic (collaboration/sequence) model, or determined by monitoring the application while it is executing known scenarios.

Code coverage of each component while executing specified scenarios.

Model parameters, such as failure rates of various component and interface types, probability distributions, failure dependencies, etc. These can be specified directly, be inferred from the model based on observations of the software application, or be retrieved from a database of historical data.

The tool generates a plurality of availability and reliability measures and other properties of the modelled system, for example:

Predicted absolute availability (e.g. in terms of 99.x %), e.g. by calculating the expected Mean Time Between Failures (MTBF) from the model and use estimates or historical data for the probability distribution of detect and repair parameters such as time to detection and time to repair, possibly in combination with probability of success of automated recovery, e.g. component micro-reboot.

Predicted relative availability (as compared to another design option, or another point of reference), e.g. by adjusting the model according to each design option or point of reference and calculating the expected reliability. The expected availability can then be determined as described above.

Other predicted reliability metrics, e.g. Mean Time To Failure (MTTF), Mean Time To Repair (MTTR).

Relative reliability as a function of certain structural or design parameters, e.g. component complexity. This allows determining the impact of poor quality or high complexity, e.g. by using a model for how a parameter such as complexity affects the reliability of the individual component, and then using the overall model to calculate the end-to-end reliability based on the component's reliability.

Some measure (“goodness-of-fit”) of how well the model fits observed data from the application (if such data is collected). This is a key indicator of the reliability of the predictions. Goodness-of-fit can be measured by a variety of parameters, e.g. by comparing a calculated MTTF with observed failure data.

Some measure of the uncertainty of the model results, such as a confidence interval for each estimated value. This is another key indicator of the reliability of the predictions.

Important aspects of the tool are the integration points between the tool and either an existing model or the software application itself and these are described in more detail. An existing model of the application's static structure and dynamic behaviour is modelled in some modelling language (e.g. UML) in some modelling tool (e.g. IBM Rational Software Architect). The software application itself, or a prototype of the application, runs by itself in some environment or embedded in some test environment or container.

For the purpose of clarity, UML is consequently used below as an example of a modelling language implemented in another tool. However, the described method and system are not limited to UML and could be integrated with any type of application modelling language.

Integration with a Design Modelling Tool (e.g. UML)

The integration between the tool and a UML modelling tool can be implemented in a number of ways. The key requirement is that the tool is able to read and understand the model.

For example, this can be achieved by having the tool issue requests to an Application Programming Interface (API) that the UML modelling tool exposes. The tool could then query for model elements to determine their properties and structure. If the UML model contains advanced information adhering to the modelling language specification (e.g. constraints and guards), the tool can interpret them. If such constructs are not used, the tool can use what is there and work with that information only. (Or combine it with information retrieved from the actual application, as described below.) This is a key usability feature: the tool does not put severe constraints on the strictness or coverage of the UML model.

If an API is not available, the tool could use any other means to retrieve the information from the UML model, including (but not limited to) accessing internal model files directly by parsing the file format, reading a standard model format that the UML tool can export, or even reading printed UML diagrams by pattern recognition and optical character recognition (OCR).

The tool is able to use any type of diagram from the UML model, including the most commonly used, such as class diagrams, sequence and collaboration diagrams, and state chart diagrams.

Integration with the Software Application

The integration between the tool and the actual software application, if it has been developed, or a prototype of the software application can be implemented in a number of ways.

For example, by using any existing interface for application management and instrumentation (e.g. JMX, Java Management Extension or JSR-319 Availability Management for Java (Java is a trade mark of Sun Microsystems, Inc.)), the tool can request execution of certain scenarios within the application and monitor its actual dynamic behaviour during the execution. In this way, the tool can obtain a large number of properties, metrics, and statistics. As examples, a call-graph can be constructed, and the dynamic structure of the application can be determined.

If the application is not in production but in a test or development system, the tool can use more active measures of gaining information, including for example automatically executing test scenarios and injecting faults while observing the application's behaviour. As examples, in the case of a Java application, faults can be injected, or test cases and scenarios can be user specified or automatically generated.

The ability of the tool to connect to existing applications allows a large number of operational characteristics to be collected. This provides significant benefits (over the prior art) when determining the overall end-to-end availability and the impact on the end-to-end availability of individual components.

If the tool is connected to an application which is in production, the tool can tailor the monitoring techniques used to ensure a minimal impact on the running application.

Optionally, the tool can be customised for a specific class of software applications, e.g. Java Enterprise applications, and provides default parameters, rules, and other customisations, that are appropriate for that type of application. It is possible to create customised versions of the tool and method for other types of software applications.

Optionally, the method and tool can be designed to support modelling only parts of applications (e.g. the most critical scenarios and components). This is useful when assessing applications that are in design and are not completed.

Optionally, the tool can connect to a database of historical data to use as basis for estimating unknown parameters, such as the failure rates of a certain component. The data can have been collected from previous uses of the tool, or by measuring live applications during operations.

Optionally, the tool can use various optimization techniques and algorithms to find an optimal configuration given some constraints, that can be specified at will. While the optimization can be performed on any parameter depending on the needs of the modeller, it is expected that a particular area of interest is to optimize the end-to-end availability, which is of key importance in complex and distributed applications, such as those found in a SOA environment.

This section contains descriptions of two embodiments of how a reliability and availability model is created. The examples used in previous literature are generally considering modular software in which the components, or modules, are serially linked together in a chain of execution. One module processes the data and then passes execution to the next module. In the component-based programming languages such as Java, the program execution follows a call graph in which components are invoked to process a request, perform the processing, and then return the control to the calling component, which then can call other components, or even the same component again with another request or another set of data to process. While this behaviour can be expressed in e.g. a UML sequence diagram, there is no obvious way of creating a state-space model out of this information. Two embodiments of translating the application's call-graph into a state-space model are explored.

Naïve Approach

In a first embodiment, a naive approach is taken in which all component invocations are modeled as state transitions from the calling component to the invoked component. In addition, for each return of control following a component invocation, a returning state transition is added. The resulting model is attractive because it closely follows the call graph and can be easily understood by anyone familiar with the application architecture. The problem with the naive model is that the expected number of visits to each state include both “proper” visits upon entering the component as well as “return” visits caused by other components returning control to the component. This essentially doubles the expected visit count for a component that calls one other component, and will cause incorrect results if estimated or measured execution times are applied to calculate the total expected execution time or the overall reliability.

### Refined Approach

In a second embodiment, a refined approach is described. By assuming that components perform all their own work directly as they are invoked, and then proceed to invoke other components, the model can ignore the fact that control is returned to a calling component after the call to another component has completed. This can be thought of as returning the control as far “back” as possible. Creating a model using the refined approach is convenient when an existing application is available and the component executions are logged. The approach can also be used when a model is created by hand from knowledge of the application design but is more difficult than the naive approach since the model will not mirror the application design as closely. However, if a runnable application (or prototype of the application) exists, it can be used to automatically create a state-based model. The application can either be instrumented using capabilities in the environment that do not require the application code to be altered, or logging statements can be introduced in the code to facilitate the analysis. Logging statements may be introduced that log each entry to and exit from a component to a specific file. By following each thread of execution, and with knowledge of what logging statement should be considered an “exit” (or “return”) from the application, an algorithm can be provided, that identifies all transitions between components and counts their frequencies. This information gives the edges in the state-graph: for each recorded transition between two states, an edge is added.

The tool has a number of features not known in the prior art:

It includes a white-box model, suitable for software applications, that takes into consideration the components of the software application and can assess and compare reliability based on various properties of each component. For example, this allows determining of the impact of individual components' reliabilities on the end-to-end availability.

It provides an integration to an existing model (e.g. expressed in the Unified Modelling Language (UML)) to automatically extract static and dynamic properties of the modelled system.

It provides the ability to integrate the tool to a running application to automatically extract operational data such as execution times and failure data, and automatically derive static and dynamic properties of the application, e.g. component relationships and call trees.

It provides the ability to interact with a running instance of the application e.g. to execute test cases and inject faults. For example, this can be used to determine individual components' reliabilities.

The main advantages as compared to existing methods are:

As compared to non-white box models, it provides a more expressive model, taking the application's structure in consideration. This results in more accurate assessment of the application's reliability.

By integrating with existing (e.g. UML) modelling and development tools, properties of the application at hand can be automatically determined and deduced. This saves time and avoids errors associated with manual re-entry of application properties into the specialised tool.

By integrating with an existing, possibly running, application, properties of the application can be automatically determined and deduced, independently or in cooperation with another model (such as UML) if one exists. This provides the benefit that another model does not have to exist, or it does not have to be completely accurate or cover the entire application. By observing the running application the tool can collect data on the dynamic behaviour and e.g. determine a graph of how components are executed in response to a certain request.

By interacting with a running instance of the application (or a prototype) the tool can determine a large number of parameters and statistics that are useful for modelling the reliability and availability. For example, the tool can request certain (different) test cases to be executed, observing how the system behaves while the cases are executed and use that information to determine what components are executed in which order, for certain scenarios. Moreover the tool can inject faults into the application while running such test cases and observe the failure behaviour to determine e.g. the sensitivity of faults of different components or scenarios. This provides a richer and more accurate modelling environment than has previously been described.

The above advantages provide a significant benefit when analysing SOA applications in which different kinds of components (different characteristics, technology, location, etc.) are combined to a business process or process flow. The modelling environment provided allows many potential combinations (of e.g. components, characteristics, and locations) to be assessed with regards to the resulting end-to-end availability, without having to construct expensive prototypes or perform excessive testing of each combination.

A reliability and availability modeling system may be provided as a service to a customer over a network.

As will be appreciated by one skilled in the art, aspects of the exemplary embodiments may be embodied as a system, method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments are described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. A method of reliability and availability modeling of a software application, comprising the steps of:
generating by a computer processor a reliability and availability model in the form of a white-box model of a software application, comprising:
inspecting at least one of an existing model of the software application's structure and behaviour and the software application;
determining the accuracy of the reliability and availability model; and
calculating reliability and availability metrics for the software application.

2. The method as claimed in claim 1, comprising determining additional input parameters relating to the software application's performance and adding the parameters to the reliability and availability model.

3. The method as claimed in claim 2, wherein determining additional input parameters relating to the software application's performance comprises interacting with a running instance of the software application or prototype.

4. The method as claimed in claim 2, wherein determining additional input parameters relating to the software application's performance comprises accessing historical data.

5. The method as claimed in claim 2, wherein determining additional input parameters relating to the software application's performance includes user input of parameters.

6. The method as claimed in claim 1, further comprising changing parameters of the software application and calculating the resulting impact on the reliability and availability.

7. The method as claimed in claim 1, further comprising changing the design of the software application, altering the reliability and availability model and calculating the resulting impact on the reliability and availability.

8. The method as claimed in claim 1, wherein the software application is formed of a plurality of components and calculating the reliability and availability comprises calculating individual components' reliability and availability.

9. The method as claimed in claim 8, wherein the components are selected from the group consisting of a software component, a hardware component, a firmware component and a microcode component.

10. A method for a reliability and availability modeling of a software application service provided to a customer comprising the steps of:
generating by a computer processor a reliability and availability model in the form of a white-box model of a software application, comprising:
inspecting at least one of an existing model of the software application's structure and behaviour and/the software application;
determining the accuracy of the reliability and availability model;
calculating reliability and availability metrics for the software application; and
providing the reliability and availability metrics for the software application to the customer.

11. A computer program product for reliability and availability modeling of a software application, the computer program product comprising:
a computer readable storage medium having computer readable program code embodied therewith, the computer readable program code comprising:
computer readable code configured to generate a reliability and availability model in the form of a white-box model of a software application, comprising:
computer readable code configured to inspect at least one of an existing model of the software application's structure and behaviour and the software application;
computer readable code configured to determine the accuracy of the reliability and availability model; and
computer readable code configured to calculate reliability and availability metrics for the software application.

12. A system of reliability and availability modeling of a software application, comprising:
a generating component to generate a reliability and/or availability model in the form of a white-box model of a software application, including obtaining information from:
a model interface to inspect an existing model of the software application's structure and behaviour;
an application interface to inspect the software application;
an accuracy determining component to determine the accuracy of the reliability and availability model; and
a calculating component to calculate reliability and availability metrics for the software application.

13. The system as claimed in claim 12, including a determining mechanism to determine input parameters relating to the software application's performance and adding the parameters to the reliability and availability model.

14. The system as claimed in claim 13, wherein the determining mechanism comprises interacting with a running instance of the software application or prototype.

15. The system as claimed in claim 13, wherein the determining mechanism includes accessing historical data.

16. The system as claimed in claim 13, wherein the determining mechanism includes user input of parameters.

17. The system as claimed in claim 13, wherein the determining mechanism includes changing parameters of the software application and calculating the resulting impact on the reliability and availability.

18. The system as claimed in claim 12, wherein the design of the software application is changed and the reliability and availability model altered and the resulting impact on the reliability and availability is calculated.

19. The system as claimed in claim 12, wherein the software application is formed of a plurality of components and the calculating component to calculate the reliability and availability includes determining individual components reliability and end-to-end availability.

20. The system as claimed in claim 19, wherein the components are selected from the group consisting of a software component, a hardware component, a firmware component and a microcode component.
